(19) United States
(12) Patent Application Publication
(10) Pub. No.: US 2013/0177178 A1
(43) Pub. Date: Jul. 11, 2013

(54) MUSICAL ADVERTISING KEYRING

(71) Applicants: Mario Sanchez Arroyo, Barcelona (ES); Teresa Arroyo Cruz, Barcelona (ES); Javier Sanchez Banos, Barcelona (ES)

(72) Inventors: Mario Sanchez Arroyo, Barcelona (ES); Teresa Arroyo Cruz, Barcelona (ES); Javier Sanchez Banos, Barcelona (ES)

(21) Appl. No.: 13/823,868

(22) PCT Filed: Sep. 17, 2011
(86) PCT No.: PCT/ES2011/000276

§ 371 Date: Mar. 15, 2013

(30) Foreign Application Priority Data
Sep. 17, 2010 (ES) U201030948

(51) Int. Cl. H04R 1/02

(52) U.S. Cl. CPC H04R 1/02
USPC 381/150

(57) ABSTRACT

MUSICAL ADVERTISING KEYRING, that with the hermetic carcass (2) that hosts in its interior an electronic mechanism form at least by battery (4), programmable microchip (5), speaker (6) and sensors, buttons or activation switches (7). Elements that are connected in a way, that when activated reproduce a melody or melodies prerecorded in the programmable microchip (5). The carcass (2) incorporates a LED (8) connected to a sensor, button or activation switch (7) and to the battery (4) of the electrical mechanism. The programmable microchip (5) is a microchip that has programmed a second alarm sound selectable at will.

### CROSS REFERENCE TO RELATED APPLICATION

This is a National Stage of International Application No. PCT/ES2011/000276, filed 17 Sep. 2011, which claims the benefit of Application No. 0201030948, filed in Spain on 17 Sep. 2010, the disclosures of which applications are incorporated by reference herein.

### BACKGROUND OF THE INVENTION

The invention as expressed in the heading of the present descriptive memory, refers to a musical advertising keyring, which provides a series of advantages and innovative characteristics of novelty, these will be described in detail later on as well as other characteristics inherent to its organization and construction which are an alternative improvement to what is known in the market for this field.

More in detail, the aim of the invention is focus in a keyring that besides being eminently destined to be an element of advertising support and/or promotional diffusion, it is structurally designed so that when the electronic device that it incorporates is activated one or more melodies that have been previously recorded in it are played and listened. These recorded melodies are related to the company, product, campaign or desired entity. The keyring can also incorporate a light device that behaves as a flashlight as well as an alarm system that can be used as a dissuasive device of defense in front of a possible attack situation against its user.

### FIELD OF THE INVENTION

The field of application of the present invention is framed inside the technical sector of the industry dedicated to the keyring manufacturing, specially focusing in the sector of the kind known as “merchandising” or promotional.

### PRECEDENTS OF THE INVENTION

At present time, and as reference to the technical state, it is important to mention that although there are multiple types and kinds of keyrings in the market, among which some have musical mechanism, but mainly toys or the infantile kind or the music box kind with string mechanisms; and others with light on the kind of a small flashlight, and other with alarm; from the applicant's part, it is unknown the existence of any keyring that presents technical, structural and constitutive characteristics similar to the ones that the keyring that here is praised has, which its characteristic details are appropriately detailed in its final recognitions that are attached to the present descriptive memory.

### SUMMARY OF THE INVENTION

In detail, what the present invention proposes is a keyring destined to be an element of advertising support and/or promotional diffusion of a company, product, campaign or entity, to which it can adopt any external configuration in which it will only be essential to exist, at least, and anchor means to fix one or more keys. Its interior will be equipped with an electronic device, composed by at least one battery, one programmable microchip, a small speaker and one or various sensors or buttons that allow the user to activate it at his will, and therefore, play one or various melodies that have been previously recorded in the keyring microchip.

Optionally, and in addition, the aforementioned electronic device, the keyring includes a LED diode that comes on when activated, so that besides playing the melody or melodies prerecorded on the microchip, it allows its use as a flashlight. For example, to make easier the introduction of the key on the lock on dark or poor lighted locations.

Finally, but also of optional form, attached or not to the light system in the electronic device of the keyring, concretely on its microchip, it is consider the programming of a sound of a more strident nature, such as a strong whistle or ringing, a buzz or any other kind of similar sound that can be identified as an alarm.

This way, the proposed keyring will also work as a dissuasive defense device against a possible incorrect attempted attack on its user. This way, when the user double activates the electronic device of the keyring, pressing the button specifically destined to it, or if it only has one, for example just keeping the sensor or activation button continually pressed during a longer period of time than usual. This will make the alarm sound and will attract the attention so that the attacker runs away.

Knowing what it precedes, it is validated that the described musical advertising keyring represents and innovative structure of constitutive and structural characteristics that are unknown until now for such purposes. This reasons united to its practical utility provides with enough basis and foundations to obtain the exclusivity privilege requested.

### BRIEF DESCRIPTION OF THE DRAWINGS

To complement the description that is being made and with the goal to help a better understanding and comprehension on the invention's characteristics, it is attached to the present descriptive memory, as a built in part of it, plans that with illustrative intentions and not restrictive the following has been represented:

FIG. 1.—Shows a simplified view of an example of the keyring fulfillment aimed of the invention. The principal parts and elements that it includes can be distinguished, as well as its configuration and layout.

### DETAILED DESCRIPTION OF THE INVENTION

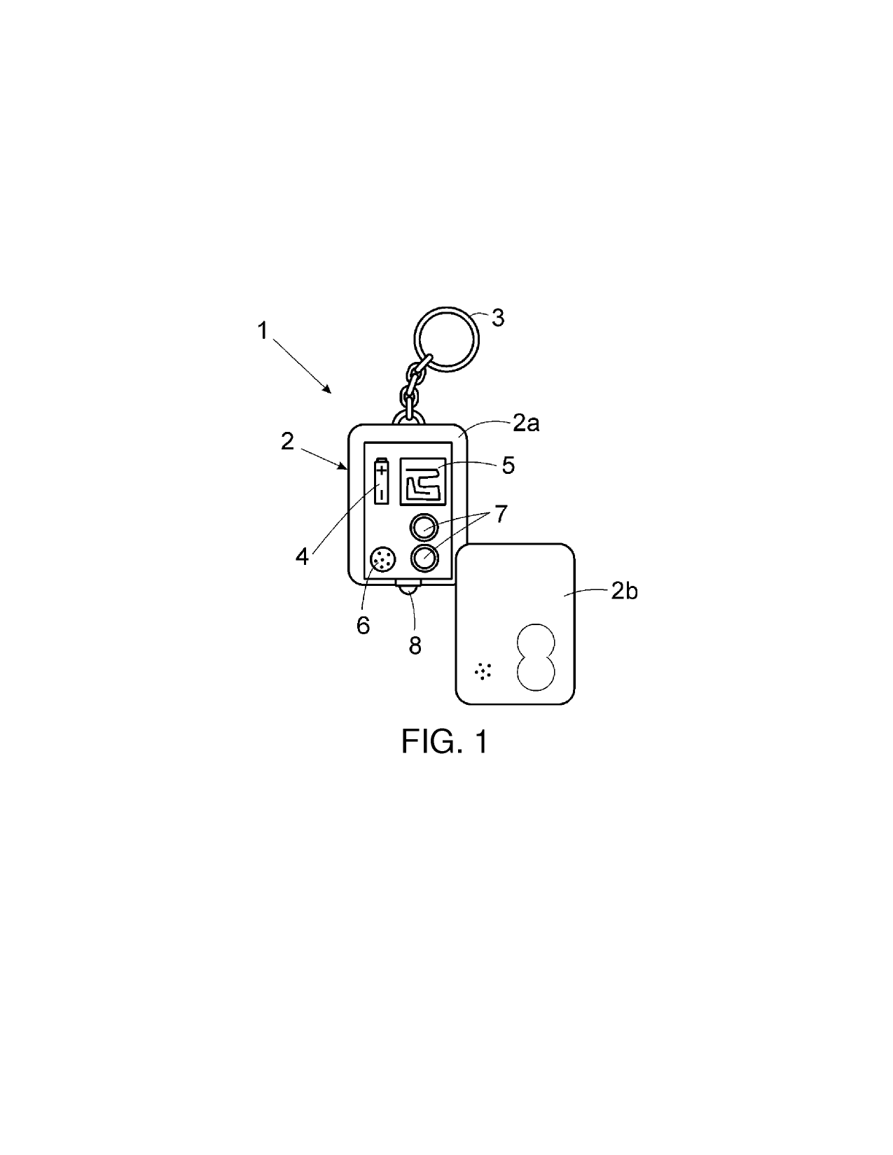

As per the described FIG. 1 and only, and as per the numbering adopted in it, it can be seen how the keyring (1) is configured on the base of a hermetic carcass (2), from any appropriate and with any external configuration, form, for example but without it being a limitation, by a base (2a) and a cover (2b), that is merged or combined to an anchor device (3) for one or more keys, such as a ring, and that internally hosts a compound electrical device, by at least one battery (4), a programmable microchip (5), a small speaker (6) and one or various sensors, buttons or activation switches (7). These elements are conveniently connected so that when the sensors, buttons or activation switches are activated (7), the keyring reproduces a melody or melodies that have been previously recorded in the programmable microchip (5).

In addition, the carcass has a LED diode (8) connected to the sensors, buttons or activation switches (7) and to the battery (4) of the electrical device, in such a way that when activated, in addition to play the melody or melodies, the diode lights.

It also, optional and independent from the incorporation of the LED diode (8), to the electrical device of the keyring (1) there is incorporated a programmable microchip (5), to which, in addition to the aforementioned melody or melodies, a strident with alarm intentions has been programmed, such as a strong whistle or ringing, a buzz or any other kind of similar sound that can be identified as an alarm. This kind of sound is selectable on will. For example, by pressing one of the sensors, buttons or activation switches (7) designed for such goal. In the case of having only one, pressing during a longer period of time than usual.

Described wide enough the nature of the present invention, as well as how to make it work, it is consider that there is no need to make the explanation more extensive for any expert in the subject to understand the range and advantages that derive from it. Making appear that inside its essential, the praised invention could be put into practice in other forms of development that differ in detail from the indicated in the title of the example, and that will always achieve protection in the same way that it is claimed, when its fundamental principle is not modified, changed or altered.

1. Musical advertising keyring, comprising a hermetic carcass that host in its interior an electronic device compound, at least, by a battery, a programmable microchip, a small speaker, and one or various sensors, buttons or activation switches connected in such a way that when these sensors, buttons or activation switches are activated, the keyring reproduces a melody or melodies that have been previously recorded in the internal programmable microchip.

2. The musical advertising keyring, according to claim 1, wherein the carcass incorporates a LED diode, connected to the at least one sensor, button, or activation switch and to the battery of the electronic mechanism, in such a way that when activated, in addition to play the melody, the diode lights.

3. The musical advertising keyring, according to claim 1, wherein the programmable microchip is a microchip that has also a second sound programmed, the second sound in the form of an alarm, wherein the second sound is selectable on will.

4. The musical advertising keyring, according to claim 1, wherein the alarm is a strong whistle, ringing, or a buzz.
